(19) United States
(12) Patent Application Publication
(10) Pub. No.: US 2006/0294290 A1
(43) Pub. Date: Dec. 28, 2006

(54) Concurrent in-application programming of programmable devices

(75) Inventors: Cathleen Raker, Rochester, NY (US); Michael Bernard Monahan, Webster, NY (US)

Correspondence Address: Edward A. Pennington, Esq.;Swidler Berlin LLP, Suite 300, 3000 K Street, N.W., Washington, DC, 20007, US

(73) Assignee: Xerox Corporation

(21) Appl. No.: 11/152,071

(22) Filed: Jun. 15, 2005

(51) Int. Cl. G06F 13/00

(52) U.S. Cl. 711/100

(57) ABSTRACT

A method, system, and computer program for concurrent in-application programming of programmable devices, such as microcontrollers, provides the capability to concurrently program multiple programmable devices that are installed in systems. A method for programming programmable devices in a system comprises determining a status of a first plurality of programmable devices, the status including information relating to program code in each programmable device, determining a subset of the plurality of programmable devices that is to be programmed, based on the information relating to program code in each programmable device; where in the subset includes a second plurality of the programmable devices, programming the second plurality of programmable devices concurrently, and determining a status of the second plurality of programmable devices, the status including information relating to success of concurrent programming of each programmable device.

### TECHNICAL FIELD

The present technology relates to a method and system for programming programmable devices, such as microcontrollers, that are in-application, that is, installed in and operational in systems that are controlled and/or monitored by the programmable devices, or in which the programmable devices provide other functionality.

### BACKGROUND OF THE TECHNOLOGY

Current designs of electronic and electro-mechanical systems incorporate programmable devices, such as microcontrollers, to control, monitor, and/or provide other functionality to the systems. The function of a programmable device is determined by the program code that is programmed into the programmable device. Such program code programmed into a programmable device is known as firmware. Typically, program code is modified in order to correct bugs that are present in the code and to add new features or functions. The modified program code must be programmed into the programmable device in order to correct the bug or add new features or functions to the system. In the past, it was necessary to remove the programmable device from the system and either replace it with a new programmable device containing the modified program code, or re-program the programmable device with the modified program code and replace it into the system. This was an expensive and time consuming process, especially in large systems that include multiple programmable devices.

More recently, it has become feasible to program or re-program programmable devices that are installed in systems without removing the programmable devices from the systems. This is known as in-application programming. In-application programming reduced the cost and time needed to program modified program code into programmable devices that are in systems. Each programmable device is individually programmed with its own firmware.

However, in large systems, which include many programmable devices, this individual programming is still an expensive and time consuming process. A need arises for a technique by which programmable devices in systems that have multiple programmable devices may be programmed more quickly and efficiently, and with reduced cost.

### SUMMARY OF THE TECHNOLOGY

A method, system, and computer program for concurrent in-application programming of programmable devices, such as microcontrollers, provides the capability to concurrently program multiple programmable devices that are installed in systems. This capability reduces the time and cost needed to program such programmable devices, especially in large systems that include many programmable devices.

A method for programming programmable devices in a system comprises determining a status of a first plurality of programmable devices, the status including information relating to program code in each programmable device, determining a subset of the plurality of programmable devices that is to be programmed, based on the information relating to program code in each programmable device; where in the subset includes a second plurality of the programmable devices, programming the second plurality of programmable devices concurrently, and determining a status of the second plurality of programmable devices, the status including information relating to success of concurrent programming of each programmable device.

The second plurality of programmable devices is programmed concurrently by sending a command to the second plurality of programmable devices to enter program mode and sending the program code to the second plurality of programmable devices. The program code is sent to the second plurality of programmable devices in one block. The programmable devices comprise at least one of a microcontroller, a microprocessor, or a computer system.

The method further comprises individually programming a programmable device that failed concurrent programming. The method further comprises erasing the second plurality of programmable devices before programming the second plurality of programmable devices concurrently.

The system is a photocopier, a xerographic photocopier, a paper handler, a document finisher, a scanner, a printer, a xerographic printer, or a fax machine.

### BRIEF DESCRIPTION OF THE DRAWINGS

Objects and advantages of the technology described in the present disclosure will be more clearly understood when considered in conjunction with the accompanying drawings, in which:

FIG. 1 is an exemplary diagram of a large system, to which the technology described in the present disclosure may be advantageously applied.

FIG. 2 is block diagram of a system architecture in which the technology described in the present disclosure may be implemented.

FIG. 3 is a flow diagram of a process of in-application programming of programmable devices.

FIG. 4 is an exemplary block diagram of a master and a programmable device in which the technology described in the present disclosure may be implemented.

### DETAILED DESCRIPTION

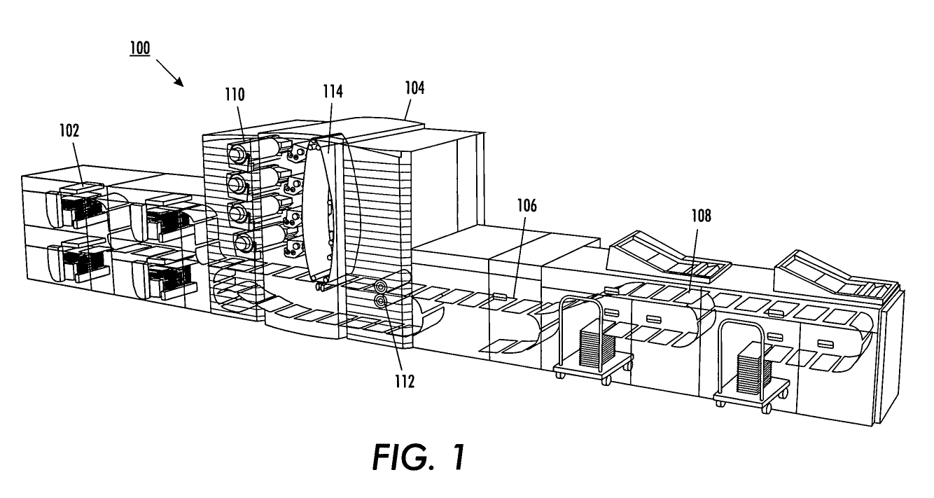

The present technology for concurrent in-application programming of programmable devices, such as microcontrollers, provides the capability to concurrently program multiple programmable devices that are installed in systems. This capability reduces the time and cost needed to program such programmable devices, especially in large systems that include many programmable devices. An example of a large system, to which the present technology may be advantageously applied, is shown in FIG. 1. The example shown in FIG. 1 is a digital production press 100, which is a large-scale production printing device capable of producing large quantities of finished documents. An example of such a system is the XEROX iGen3™ 110 Digital Production Press. A large number of programmable devices are distributed throughout press 100, such as in the paper feeders 102, the imaging unit 104, the post process inserter 106, and the document finishers 108. For example, in the paper feeders 102, programmable devices may control the rollers that feed the paper, guides, tampers, and sensors that align the paper, detectors that indicate the paper level in the paper feeder, etc. In imaging unit 104, programmable devices may control the operation of imaging stations and image carrier 110, fuser 112, ink containers 114, as well as rollers that feed the paper and guides, tampers, and sensors that align the paper, etc. In post process inserter 106, programmable devices may control the rollers that feed the paper and the inserts, guides, tampers, and sensors that align the paper and the inserts, etc. In document finisher 108, programmable devices may control the rollers that feed the paper, guides, tampers, and sensors that align the paper, punches that punch holes in the documents, binders that bind the pages into documents, etc. In addition, programmable devices may perform interface functions, to provide the capability to control and administer press 100 from other systems, user interface functions, to display information to users and accept user input, and other functions.

It is to be noted that press 100, shown in FIG. 1, is merely an example of a system to which the present technology may be advantageously applied. The present technology is not limited to this system and in fact, contemplates application to and implementation in any type of system in which multiple programmable devices may be programmed. Additional non-limiting examples of systems to which the present technology may be applied include xerographic or other photocopiers, paper handlers, document finishers, scanners, printers, fax machines, etc. In addition, one of skill in the art would recognize that the present technology is not limited to implementation with programmable devices. Although, for simplicity, this document uses the term programmable device, it is to be understood that the present technology may be implemented relative to any type of software or firmware based processor, such as microcontrollers, microprocessors, computer systems, etc., and that the term programmable device encompasses any such software or firmware based processor.

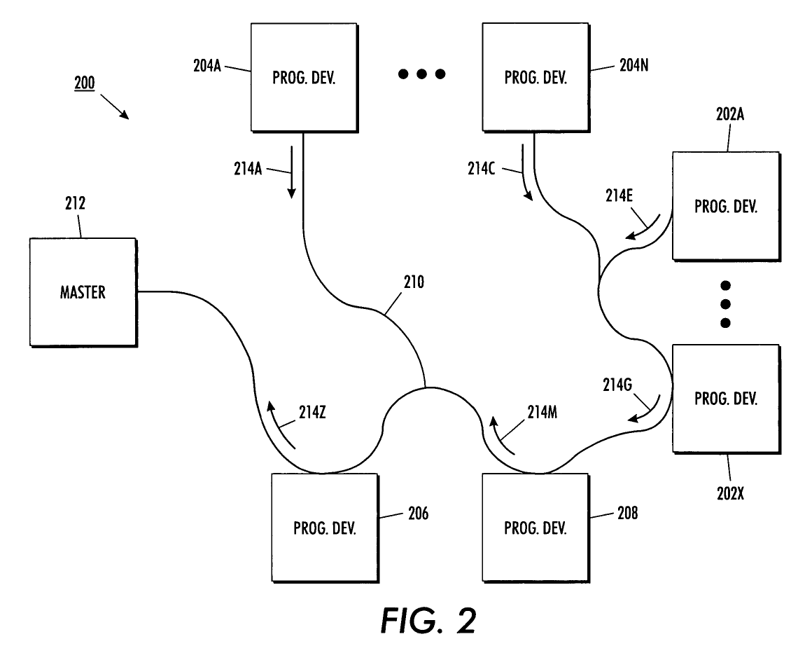

An example of a programmable device programming architecture 200 for programming multiple programmable devices is shown in FIG. 2. Architecture 200 includes multiple programmable devices, which may be arranged in groups, such as programmable devices 202A-X and programmable devices 204A-N, or individually, such as programmable devices 206 and 208. The programmable devices are communicatively connected by a communication path 210, which may be a network, such as a standard local area network (LAN) or wide area network (WAN), such as Ethernet, Token Ring, the Internet, a private or proprietary LAN/WAN, a data bus that transfers data between programmable devices, such as the S-100 bus (IEEE 696), the ISA bus, the Extended ISA (EISA) bus, the MicroChannel (MCA) bus, the NuBus (IEEE 1196), the SBus (IEEE 1496), the Peripheral Component Interconnect (PCI) bus, the VMEbus, the VERSAmodule Eurocard bus, the STD Bus, the 1-Wire bus, the I2C bus, the Serial Peripheral Interface Bus (SPI), the HyperTransport bus, the PCI Express bus, the Advanced Technology Attachment (ATA, aka IDE, EIDE, ATAPI, etc.) bus, the IEEE-488 bus, the HIgh Performance Parallel Interface (HIPPI) bus, the PCMCIA bus, the Small Computer System Interface SCSI bus, the Centronics parallel bus, the ACCESS.bus (A.b) bus, the Apple Desktop Bus (ADB) bus, the Fibre Channel bus, the IEEE 1394 (FireWire) bus, the RS-485 bus, the Serial ATA bus, the Serial Storage Architecture (SSA) bus, the Universal Serial Bus (USB), the Controller Area Network (CAN), the Serial Command Bus (SCB), etc. Communication paths may use parallel or bit-serial connections, and can be wired in either a multidrop (electrical parallel) or daisy chain topology, or connected by switched hubs, as in the case of USB. For example, the XEROX iGen3™ 110 Digital Production Press, which is an example of a system shown in FIG. 1, uses the Serial Command Bus (SCB).

It is to be noted that the networks and busses described above are merely examples of a communication paths to which the present technology may be advantageously applied. The present technology is not limited to these communication paths and contemplates application to and implementation with any type of communication path by which multiple programmable devices may be programmed.

Architecture 200 also includes master 212. Master 212 is a processor that is communicatively connected to programmable devices 202A-X, 204A-N, 206, and 208 through communication path 210. Master 212 may be a microcontroller, but master 212 may be implemented in a microprocessor, a computer system, etc. Master 212 stores, or connects to a system (not shown) that stores new program code that is to be programmed into at least some of the programmable devices 202A-X, 204A-N, 206, and 208. The present technology allows program code updates to be performed with In-Application Programming. In-Application Programming (IAP) means that the programmable devices to be updated receive new program code from the master 212 and reprogram themselves while in the system. For example, program code updates may be limited to program code revision updates, but, depending upon the system implementation, program code version updates may be allowed.

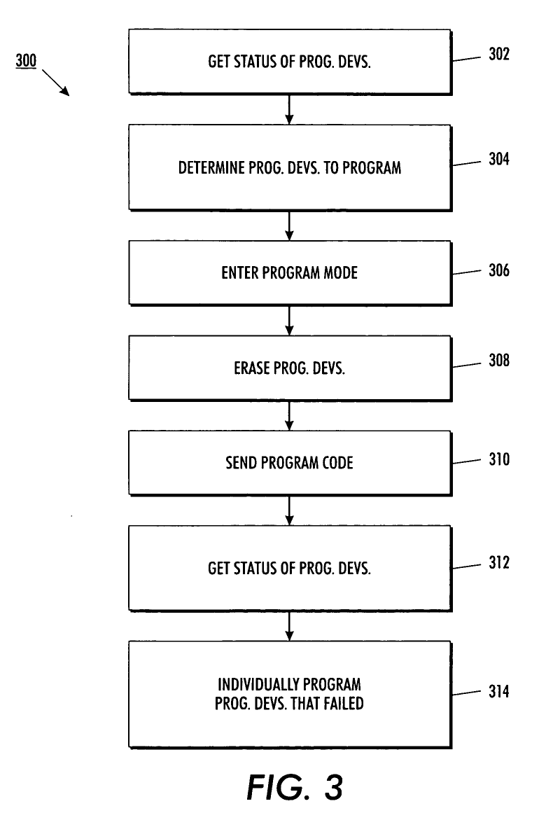

A process 300 of concurrent in-application programming of programmable devices is shown in FIG. 3. It is best viewed in conjunction with FIG. 2. Process 300 begins with step 302, in which master 212 obtains the statuses 214A-Z of programmable devices 202A-X, 204A-N, 206, and 208 through communication path 210. The obtained status 214A-X may include identifying information such as the PWBA or board ID and the firmware version and revision of the programmable device. The version/revision number of a programmable device indicates the hardware dependency level. For example, program code of the same version number may be updated in any programmable device.

In step 304, it is determined which programmable devices are to be programmed. The PWBA ID and the firmware version and revision of the programmable device are used to determine which programmable devices are to be programmed, and with which new program code file they are to be programmed.

Each program code file that is available to be programmed into a programmable device includes information indicating the PWBA ID to which the file is applicable, as well as the version and revision numbers of the files. For example, a program code file that is available to be programmed into a programmable device may be an ASCII file in the well-known INTEL® HEX file format. In this example, the last INTEL hex record is an End-Of-File record which contains identification coding and may have an exemplary format such as:

:01vvrrttxxcc where xx contains the PWBA ID of the smart remote,
vv contains the version,
rr contains the revision,
cc is the checksum of the record.
tt=01, end-of-file record type
   The first 01 signifies 1 data byte.

For example, a program code file may be programmed into a programmable device that has a PWBA ID and version number that matches those of the program code file. In other embodiments, a program code file may be programmed into a programmable device that has a PWBA ID that matches those of the program code file, or a program code file may be programmed into a programmable device regardless of the IDs of the programmable devices. As an additional example, if the programmable device program code reports a version.revision of x.255, where x is the board (Printed Wire Board Assembly (PWBA)) hardware level, the programmable device does not contain any functional firmware and requires an update. This can occur if a previous attempt to program new program code failed or a program code checksum failed upon reset. If the programmable device does not have program code programming capability, it will be unable to enter the programming mode.

In step 306, programming mode is entered for those programmable devices that are to be programmed with a particular program code file. Master 212 transmits commands over communication path 210 to cause those programmable devices that are to be programmed to enter the concurrent programming mode. Typically, architecture 200 provides the capability to program programmable devices individually, or to program multiple programmable devices concurrently. In order to support both programming modes, the commands used to enter individual programmable device programming mode are typically different than the commands used to enter concurrent multiple programmable device programming mode. For example, a command sequence to enter the flash programming mode for a single programmable device using the SCB may be defined as follows;

WriteWord 00 dd00 (Write Word “dd00” to address “00”)
where dd is the PWBA ID.
   Cmd 06-SCB Command Number to enter single flash programming mode.

Likewise, as an example, programmable devices with the same PWBA ID on a single SCB communication path can take advantage of having their program code updated concurrently. The command sequence to enter the flash programming mode for multiple programmable devices using the SCB may be defined as follows;

WriteWord 00 dd00 (Write Word “dd00” to address “00”)
where dd is the PWBA ID.
   Cmd 07-SCB Command Number to enter bulk flash programming mode.

One consideration is that multiple concurrent programmable device programming on an SCB communication path requires longer erasure and programming times. When individual programmable devices are programmed, handshaking may be performed between the master 212 and the programmable device being programmed. This allows the master 212 to verify that the programmable device has been programmed properly and allows nominal erasure and programming tolerances to be used. No handshaking between each programmable device and the master 212 occurs during multiple concurrent programmable device programming because otherwise communication collisions would occur. In this case, maximum erasure and programming tolerances are used by the master. However, if a different communication path technology is used, it may be possible to perform handshaking with multiple programmable devices during concurrent programming. This is dependent upon the communication path technology used.

Typically, a programmable device must be erased prior to programming new programming code. In step 308, master 212 commands those programmable devices that are to be programmed to erase at least a portion of their non-volatile memories. Erasure may be done individually or concurrently. For example, after erasure, each programmable device may retain boot code for protection against power failure or other programming failure. Likewise, the programmable device may retain the program code version number from the original build at the manufacturer, in order to retain the hardware-firmware dependencies.

In step 310, program code is send over communication path 210 to all programmable devices that are being programmed. Each programmable device that is being programmed receives the program code, performs error checking, such as generating one or more CRCs, and programs the program code into non-volatile memory of the programmable device. Since, in the example of an SCB communication path, no handshaking occurs during programming in concurrent multiple programmable device programming mode, all program code is sent in one block. By contrast, in single programmable device programming mode, handshaking occurs, so the program code is sent in multiple blocks, with handshaking providing verification of correct receipt of each block, and possible retransmission of block occurring.

When transmission of the program code is completed, in step 312, master 212 obtains the status of all programmable devices that were programmed. Those programmable devices that indicate as their status that the programming procedure was successfully completed are done. However, those programmable devices that indicate as their status that the programming procedure was not successfully completed require further processing. In step 314, programming of those programmable devices for which the programming procedure was not successfully completed are programmed again individually, using single programmable device programming mode.

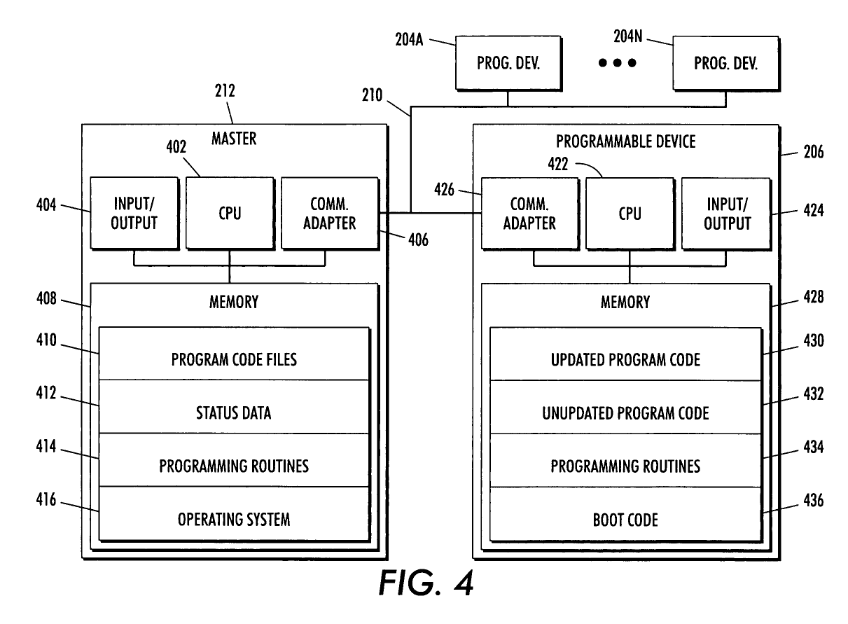

Exemplary block diagrams of a master and a programmable device are shown in FIG. 4. Master 212 is typically a microcontroller, but master 212 may be implemented in a microprocessor, a dedicated computer system, a programmed general-purpose computer system, such as a personal computer, workstation, server system, and minicomputer or mainframe computer. Master 212 includes processor (CPU) 402, input/output circuitry 404, communication adapter 406, and memory 408. CPU 402 executes program instructions in order to carry out the functions of master 212. Input/output circuitry 404 provides the capability to input data and/or control signals to, or output data and/or control signals from, master 212. For example, input/output circuitry may include input devices, such as keyboards, mice, touchpads, trackballs, scanners, etc., output devices, such as video adapters, monitors, printers, etc., and input/output devices, such as, modems, etc. Communication adapter 406 interfaces master 212 with communication path 210. Communication path 210 may be any standard or proprietary network or data bus. Communication path 210 provides communicative connectivity to programmable devices connected to communication path 210, such as programmable devices 204A-N and 206.

Memory 408 stores program instructions that are executed by, and data that are used and processed by, CPU 402 to perform the functions of the present technology. Memory 408 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 408 includes program code files 410, status data 412, programming routines 414, and operating system 416. Program code files 410 are files including program code that is available to be programmed into programmable devices, such as programmable devices 204A-N and 206. Status data 412 is data indicating the PWBA ID, version/revision information, and programming success or failure of programmable devices, such as programmable devices 204A-N and 206. Programming routines 414 are routines that implement a process of concurrent programming of multiple programmable devices, such as programmable devices 204A-N and 206, and which may also include a process of individual programming of such programmable devices. Operating system 420 provides overall system functionality.

Programmable device 206 includes processor (CPU) 422, input/output circuitry 424, communication adapter 426, and memory 428. CPU 422 executes program instructions in order to carry out the functions of programmable device 206. Input/output circuitry 424 provides the capability to input data and/or control signals to, or output data and/or control signals from, programmable device 206. For example, input/output circuitry may include input devices, such as keyboards, mice, touchpads, trackballs, scanners, etc., output devices, such as video adapters, monitors, printers, etc., and input/output devices, such as, modems, etc. Communication adapter 426 interfaces programmable device 206 with communication path 210. Communication path 210 provides communicative connectivity to master 212.

Memory 428 stores program instructions that are executed by, and data that are used and processed by, CPU 422 to perform the functions of the present technology. Memory 428 may include electronic memory devices, such as random-access memory (RAM), read-only memory (ROM), programmable read-only memory (PROM), electrically erasable programmable read-only memory (EEPROM), flash memory, etc., and electro-mechanical memory, such as magnetic disk drives, tape drives, optical disk drives, etc., which may use an integrated drive electronics (IDE) interface, or a variation or enhancement thereof, such as enhanced IDE (EIDE) or ultra direct memory access (UDMA), or a small computer system interface (SCSI) based interface, or a variation or enhancement thereof, such as fast-SCSI, wide-SCSI, fast and wide-SCSI, etc, or a fiber channel-arbitrated loop (FC-AL) interface.

Memory 428 includes updated program code 430, unupdated program code 432, programming routines 434, and boot code 436. Updated program code 430 is program code, which may be stored in non-volatile memory and which has been programmed into programmable device 206 using a process of concurrent programming of multiple programmable devices and/or a process of individual programming of such programmable devices. Unupdated program code 432 is program code, which may be stored in non-volatile memory and which has not been programmed into programmable device 206 using such processes. Depending upon the implementation and architecture of programmable device 206 and the programming processes, there may or may not be any updated program code 430 or any unupdated program code present in programmable device 432 at any given time. However, after successful performance of a programming process, at least updated program code 430 will be present in programmable device 432. Programming routines 434 are routines that implement the programmable device-based portion of a process of concurrent programming of multiple programmable devices, such as programmable devices 204A-N and 206, and which may also include a process of individual programming of such programmable devices. Boot code 436, which may be non-volatile and non-erasable, provides programmable device 206 with the capability to boot from power up or reset, even in the case that a process of programming the programmable device failed to successfully complete. Although not shown, an operating system may also be present, depending upon the implementation.

One of skill in the art would recognize that memory 428 includes at least some non-volatile memory that is used to store at least some of the program code that implements the functionality of programmable device 206. The arrangement of storage of the various elements in memory 428 in volatile or non-volatile memory, or in erasable or non-erasable non-volatile memory, or in any particular type or technology of memory is an implementation decision dependent upon the implementation of the programmable devices, the master, and the system that is well within the knowledge of one of skill in the art. The present technology is applicable to, and contemplates implementation in, any such memory arrangement.

Although specific embodiments of the present technology have been described, it will be understood by those of skill in the art that there are other embodiments that are equivalent to the described embodiments. Accordingly, it is to be understood that the technology is not to be limited by the specific illustrated embodiments, but only by the scope of the appended claims.

1. A method for programming programmable devices in a system comprising:
determining a status of a first plurality of programmable devices, the status including information relating to program code in each programmable device;
determining a subset of the plurality of programmable devices that is to be programmed, based on the information relating to program code in each programmable device; where in the subset includes a second plurality of the programmable devices;
programming the second plurality of programmable devices concurrently; and
determining a status of the second plurality of programmable devices, the status including information relating to success of concurrent programming of each programmable device.

2. The method of claim 1, wherein the second plurality of programmable devices is programmed concurrently by:
sending a command to the second plurality of programmable devices to enter program mode; and
sending the program code to the second plurality of programmable devices.

3. The method of claim 2, wherein the program code is sent to the second plurality of programmable devices in one block.

4. The method of claim 2, wherein the programmable devices comprise at least one of a microcontroller, a microprocessor, or a computer system.

5. The method of claim 2, further comprising individually programming a programmable device that failed concurrent programming.

6. The method of claim 5, further comprising erasing the second plurality of programmable devices before programming the second plurality of programmable devices concurrently.

7. The method of claim 2, wherein the system is a photocopier, a xerographic photocopier, a paper handler, a document finisher, a scanner, a printer, a xerographic printer, or a fax machine.

8. Apparatus for programming programmable devices in a system comprising:
a master device operable to store a program code file to be programmed into programmable devices; and
a communication path communicatively connecting the master device to a first plurality of programmable devices in the system;
wherein the master device is further operable to determining a status of the first plurality of programmable devices, the status including information relating to program code in each programmable device; determine a subset of the plurality of programmable devices that is to be programmed, based on the information relating to program code in each programmable device; where in the subset includes a second plurality of the programmable devices; program the second plurality of programmable devices concurrently using the program code file; and determine a status of the second plurality of programmable devices, the status including information relating to success of concurrent programming of each programmable device.

9. The apparatus of claim 8, wherein the master device is further operable to program the second plurality of programmable devices concurrently by:
sending a command to the second plurality of programmable devices to enter program mode; and
sending the program code file to the second plurality of programmable devices.

10. The apparatus of claim 8, wherein the program code file is sent to the second plurality of programmable devices in one block.

11. The apparatus of claim 9, wherein the programmable devices comprise at least one of a microcontroller, a microprocessor, or a computer system.

12. The apparatus of claim 9, wherein the master comprises at least one of a microcontroller, a microprocessor, or a computer system.

13. The apparatus of claim 9, wherein the master device is further operable to individually program a programmable device that failed concurrent programming.

14. The apparatus of claim 12, wherein the master device is further operable to erase the second plurality of programmable devices before programming the second plurality of programmable devices concurrently.

15. The apparatus of claim 9, wherein the system is a photocopier, a xerographic photocopier, a paper handler, a document finisher, a scanner, a printer, a xerographic printer, or a fax machine.

16. A computer program product for programming programmable devices in a system comprising:
a computer readable medium;
computer program instructions, recorded on the computer readable medium, executable by a processor, for performing the steps of:
determining a status of a first plurality of programmable devices, the status including information relating to program code in each programmable device;
determining a subset of the plurality of programmable devices that is to be programmed, based on the information relating to program code in each programmable device; where in the subset includes a second plurality of the programmable devices;
programming the second plurality of programmable devices concurrently; and
determining a status of the second plurality of programmable devices, the status including information relating to success of concurrent programming of each programmable device.

17. The computer program product of claim 16, wherein the second plurality of programmable devices is programmed concurrently by:
sending a command to the second plurality of programmable devices to enter program mode; and
sending the program code to the second plurality of programmable devices.

18. The computer program product of claim 17, wherein the program code is sent to the second plurality of programmable devices in one block.

19. The computer program product of claim 18, wherein the programmable devices comprise at least one of a microcontroller, a microprocessor, or a computer system and wherein the system is a photocopier, a xerographic photocopier, a paper handler, a document finisher, a scanner, a printer, a xerographic printer, or a fax machine.

20. The computer program product of claim 17, further comprising individually programming a programmable device that failed concurrent programming and erasing the second plurality of programmable devices before programming the second plurality of programmable devices concurrently.
